(19) United States
(12) Patent Application Publication
(10) Pub. No.: US 2007/0049251 A1
(43) Pub. Date: Mar. 1, 2007

(54) Method and system for wireless communication in emergency situations

(76) Inventors: Von A. Mock, Boynton Beach, FL (US); Eric T. Eaton, Lake Worth, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/216,290

(22) Filed: Aug. 31, 2005

(51) Int. Cl. H04M 1/66

(52) U.S. Cl. 455/411

(57) ABSTRACT

A method and a system for enabling an enhanced operating mode of a mobile communication device (102) are disclosed. The method includes receiving (502) an authorization message from an authority (104) that is capable of communicating wirelessly with the mobile communication device. The authorization message is then checked (504) for authenticity of the authority. On authentication of the authorization message, the enhanced operating mode of the mobile communication device is enabled (506), allowing communication between the authority and the mobile communication device, even in emergencies.

### FIELD OF THE PRESENT INVENTION

The present invention relates in general to the field of wireless communication. More specifically, the present invention relates to wireless communication in emergencies.

### BACKGROUND OF THE PRESENT INVENTION

Wireless devices, for example, mobile phones, have widespread use in almost all spheres of life today. They are particularly helpful in emergencies such as accidents, mishaps or natural calamities. Victims in such situations need help urgently. Wireless communication devices such as mobile phones enable these victims to inform rescue teams about their location.

Technologies such as Family Radio Services (FRS) and Very High Frequency (VHF) enable such communication. Wireless communication devices, based on FRS, include walkie-talkie systems. These systems work on the Ultra High Frequency (UHF) band, enabling bi-directional, point-to-point communication between a victim and a rescue team.

Other technologies entail providing the rescue team with vehicles such as aircrafts with individual transceivers. These transceivers are capable of transmitting data signals to, and receiving information signals from, the victim's mobile communication device. Further, these transceivers act as individual transceiver towers for the victim's mobile communication device, thereby facilitating wireless communication with him/her.

However, the technologies described above restrict communication between the victim and the rescue team to a limited physical range. This is because communication with a mobile communication device depends on presence of the mobile communication device in the range of a transceiver, and vice versa. Moreover, the mobile communication device may be running low on power, or the victim may not be able to use it to inform the rescue team about his location. These frequently result in delays in tracking the victim, causing him great discomfort. Moreover, the additional cost incurred in carrying out a long drawn-out rescue operation can be considerable.

### BRIEF DESCRIPTION OF THE DRAWINGS

The present invention is illustrated by way of example, and not limitation, in the accompanying figures, in which like references indicate similar elements, and in which:

FIG. 1 depicts an exemplary environment in which various embodiments of the present invention may be practiced;

FIG. 2 is a block diagram illustrating components of a mobile communication device, in accordance with an embodiment of the present invention;

FIG. 3 is a block diagram illustrating components of an enhanced operating mode module, in accordance with an embodiment of the present invention;

FIG. 4 is a block diagram illustrating components of an authority, in accordance with an embodiment of the present invention; and

FIG. 5 is a flowchart illustrating a method for enabling an enhanced operating mode of a mobile communication device, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements, to aid in understanding embodiments of the present invention.

### DETAILED DESCRIPTION OF THE VARIOUS EMBODIMENTS

Before describing in detail the particular method and system for wireless communication in emergency situations, in accordance with the present invention, it should be observed that the present invention resides primarily in combinations of method steps and apparatus components related to the method and system, for wireless communication in emergency situations. Accordingly, the apparatus components and method steps have been represented where appropriate by conventional symbols in the drawings. These show only the specific details that are pertinent for an understanding of the present invention, so as not to obscure the disclosure with details that will be readily apparent to those of ordinary skill in the art, with the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The term “another”, as used herein, is defined as at least a second or more. The terms “including” and/or “having”, as used herein, are defined as comprising. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system.

In one embodiment of the present invention, a method for enabling an enhanced operating mode of a mobile communication device is provided. To enable the enhanced operating mode, an authorization message is received from an authority. The authorization massage is authenticated. The enhanced operating mode of the mobile communication device is then enabled in response to authenticating the authorization message.

In another embodiment of the present invention, a mobile communication device having an enhanced operating mode is provided. The mobile communication device includes means for receiving an authorization message, means for authenticating the authorization message, and means for providing the enhanced operating mode of the mobile communication device. The authorization message is received from an authority.

In yet another embodiment of the present invention, a computer program product for enabling an enhanced operating mode of a mobile communication device is provided. The computer program product includes a computer readable medium including program instruction means for receiving an authorization message from an authority, authenticating the authorization message, and providing the enhanced operating mode of the mobile communication device.

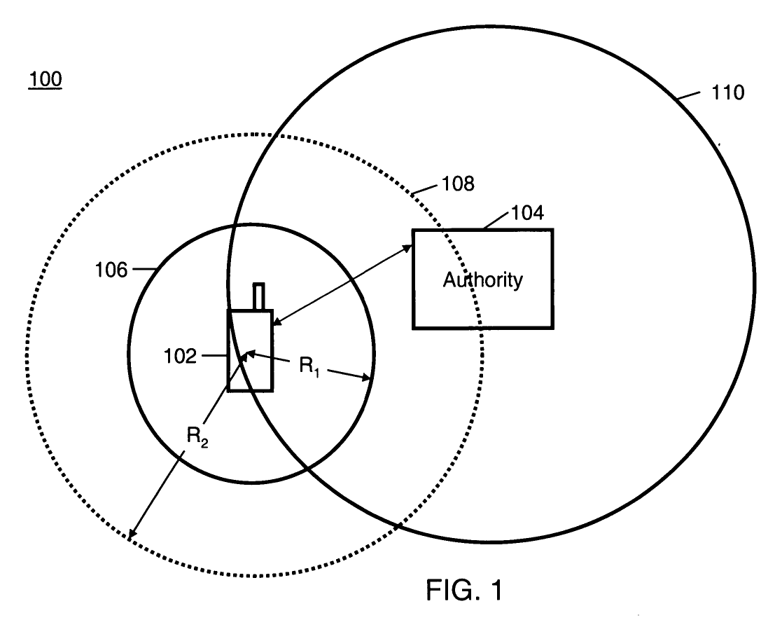

FIG. 1 depicts an exemplary environment 100, in which various embodiments of the present invention may be practiced. In this exemplary environment, a mobile communication device 102 is capable of communicating with an authority 104. Examples of the mobile communication device 102 include a mobile phone, a Personal Digital Assistant (PDA), and a Global Positioning System (GPS) device. Examples of the authority 104 include, but are not limited to, a transceiver station in an airplane and a direct radio communication set in a helicopter. There may be multiple such mobile communication devices and authorities in the exemplary environment 100.

In accordance with some embodiments of the present invention, the mobile communication device 102 is capable of operating in different modes, such as a normal operating mode and an enhanced operating mode. To operate in the enhanced operating mode, one or more transmit parameters of the mobile communication device 102 are adjusted. The transmit parameters relate to, for example, a transmit power, power consumption and various signals transmitted by the mobile communication device 102. The mobile communication device 102 communicates with the authority 104 by using wireless means, for example, radio waves. For this purpose, the mobile communication device 102 as well as the authority 104 have transmission ranges over which they can transmit signals.

Range circles 106, 108 and 110, shown in FIG. 1, depict the transmission ranges of the mobile communication device 102 and the authority 104, in accordance with various embodiments of the present invention. In the normal operation mode, the transmission range of the mobile communication device 102 is depicted by a range circle 106 with a radius ‘R₁’. The authority 104 may or may not lie within the transmission range in the normal operation mode. Therefore, it may not be possible for the authority 104 to receive transmissions from the mobile communication device 102 while in the normal operation mode of the mobile communication device 102. However, in the enhanced operating mode, the transmission range of the mobile communication device 102 increases to a radius of ‘R₂’. A range circle 108 with the radius of ‘R₂’ depicts the increased transmission range. The authority may now lie within the increased transmission range. Therefore, the possibility of communicating with the authority 104 increases in the enhanced operation mode. For example, in FIG. 1, the authority 104 lies within the increased transmission range of the mobile communication device 102, and therefore, receives transmissions from the mobile communication device 102. Similarly, a range circle 110 shows the transmission range of the authority 104, which is capable of sending data signals to the mobile communication device 102.

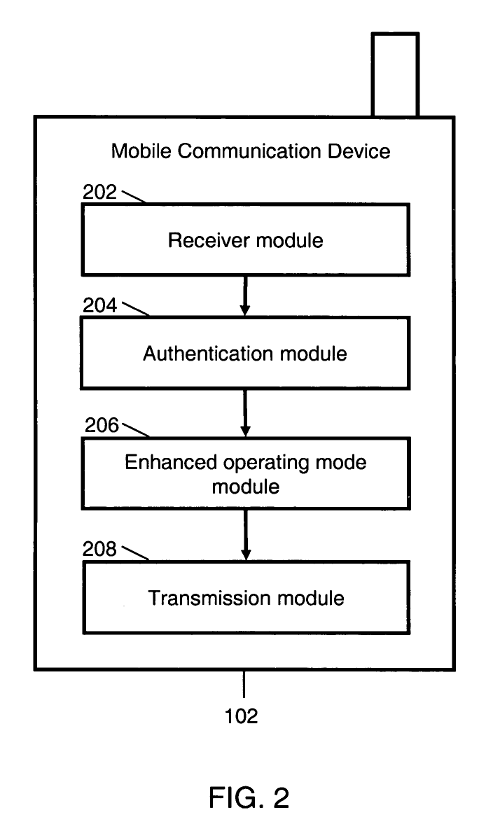

FIG. 2 is a block diagram illustrating components of the mobile communication device 102, in accordance with an embodiment of the present invention. The mobile communication device 102 includes a receiver module 202, an authentication module 204, an enhanced operating mode module 206, and a transmission module 208. The receiver module 202 is a means for receiving an authorization message. The authorization message includes instructions for the mobile communication device 102, to enable the enhanced operating mode of the mobile communication device 102. The authorization message is received from the authority 104. In an embodiment of the present invention, the authorization message includes a digital authorization certificate of the authority 104. The digital authorization certificate is an identification code associated with the authority 104. The receiver module 202 also receives the data signals transmitted by the authority 104. The authentication module 204 is a means for authenticating the digital authorization certificate. The authentication module 204 checks the digital authorization certificate to authenticate the authority 104. For example, the authentication module 204 checks a predefined list of digital authorization certificates of valid emergency authorities. If the digital authorization certificate matches any digital authorization certificate in the predefined list, the authority 104 is authenticated. The valid emergency authorities are entitled to carry out rescue operations and can enable the enhanced operating mode of the mobile communication device 102 in emergencies. Examples of valid emergency authorities include the Wilderness Search and Rescue of South Africa, and the United States Coast Guards.

On authenticating the digital authorization certificate, the enhanced operating mode module 206 enables the enhanced operating mode of the mobile communication device 102. In other words, the enhanced operating mode module 206 is means for providing the enhanced operating mode of the mobile communication device 102. The adjustment of the transmit parameters conforms to the instructions in the authorization message. In the enhanced operating mode, the transmission module 208 can communicate with the authority 104. In accordance with an exemplary embodiment of the present invention, the transmission module 208 transmits information signals with an increased range over the range circle 108 in the enhanced operating mode. The information signals are transmitted according to a transmit timing sequence. The transmit timing sequence determines the periodicity of the information signals being transmitted by the mobile communication device 102. Therefore, the information signals are reliably transmitted over a distance of ‘R₂’ from the point of transmission.

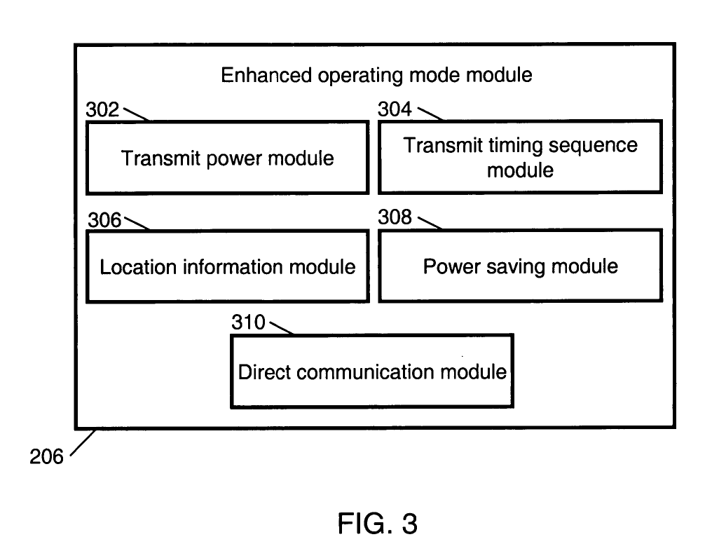

FIG. 3 is a block diagram illustrating the components of the enhanced operating mode module 206, in accordance with an embodiment of the present invention. The enhanced operating mode module 206 includes a transmit power module 302, a transmit timing sequence module 304, a location information module 306, a power saving module 308, and a direct communication module 310. The transmit power module 302 is a means for varying the transmit power of the mobile communication device 102. The transmit power refers to the power at which the transmission module 208 transmits, for example, the information signals. In the enhanced operating mode, the transmit power may be increased to a value that is more than a predefined value used in the normal operating mode. This changes the transmission range of the mobile communication device 102 to an increased transmission range, for example, the range circle 108.

The transmit timing sequence module 304 serves as a means for adjusting the transmit timing sequence of the transmission module 208. This adjustment depends on the instructions in the authorization message. The transmit timing sequence is adjusted so that the mobile communication device 102 can repeatedly transmit an information signal. In one embodiment of the present invention, the information signal is transmitted a predefined number of times to increase the sensitivity of the transmission. In an exemplary embodiment of the present invention, a bit-combining algorithm may be employed to transmit the information signal.

In another embodiment of the present invention, the information signal is transmitted periodically. In other words, the transmission of the information signal is repeated after a fixed interval. The authority 104 can determine the location information of a user of the mobile communication device 102 from the information signal. For example, the authority 104 may process the information signals, using Doppler's shift techniques, by measuring their arrival time to determine the location of the mobile communication device 102.

In an embodiment of the present invention, the mobile communication device 102 is capable of determining its own location. The location information module 306 is means for transmitting the location information of the mobile communication device 102. In order to do this, information about the location of the mobile communication device 102 is obtained, for example, by using GPS services. The transmission module 208 then transmits the location information, which may be received by the authority 104. The authority 104 uses the location information to track the user of the mobile communication device 102.

In another embodiment of the present invention, the mobile communication device 102 transmits response signals or specific signals in response to a request signal from the authority 104. The authority 104 can then process the response signals to determine the location of the mobile communication device 102.

In the event the mobile communication device 102 is low on battery power, the power saving module 308 in the mobile communication device 102 can lower power consumption. The power saving module 308 is a means for enabling the power-saving mode of the mobile communication device. For example, once the enhanced operating mode is enabled, the receiver module 202 may be deactivated or disabled, so that the mobile communication device 102 can only transmit information signals to the authority 104. As another example, the mobile communication device 102 may also be enabled, to use the reserve power in a battery.

The direct communication module 310 is capable of establishing a direct communication link with the authority 104. The direct communication link enables two-way direct communication between the mobile communication device 102 and the authority 104, without a transceiver tower. Examples of the direct communication link include a walky-talky link and Family Radio Service (FRS) over long ranges.

In an alternative embodiment of the present invention, an indication is given to the user of the mobile communication device 102, on receiving the authorization message from the authority 104. The user can also be informed when a communication link has been established with the authority 104. The receiver module 202 is coupled to a user interface, such as a visual display of the mobile communication device 102, for this purpose. For example, the visual display can show a particular icon on the mobile communication device 102 on receiving the authorization message. As another example, a message can also be shown on the visual display when the communication link has been established.

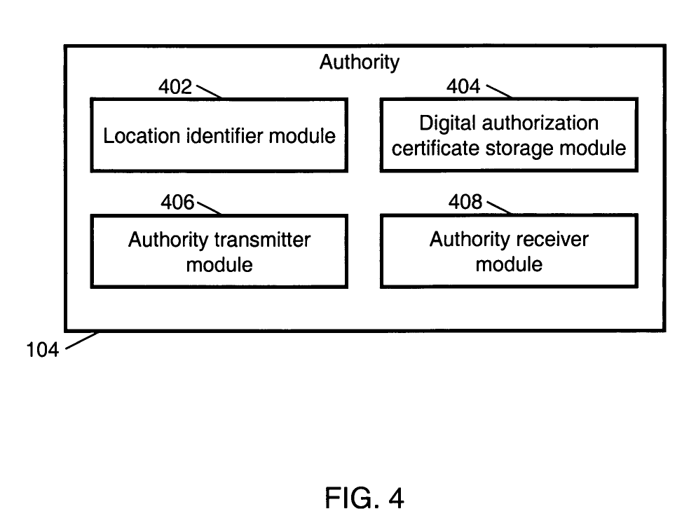

FIG. 4 is a block diagram illustrating the components of the authority 104, in accordance with an embodiment of the present invention. The authority 104 includes a location identifier module 402, a digital authorization certificate storage module 404, an authority transmitter module 406, and an authority receiver module 408. The location identifier module 402 is a means for identifying the location of the mobile communication device 102. The location identifier module 402 processes the response signals transmitted by the mobile communication device 102 by using triangulation techniques, and determines the location of the mobile communication device 102. The location of the mobile communication device 102 includes information about the distance of the mobile communication device 102 from the authority 104, and the direction in which the mobile communication device 102 is located relative to the authority 104. In an embodiment of the present invention, the location identifier module 402 receives the GPS information from the mobile communication device 102, to determine its location. In another embodiment of the present invention, the authority 104 includes multiple antennas, installed orthogonally with respect to one another, which receive the information signals from the mobile communication device 102. The location identifier module 402 then processes the information signals, to determine the location of the mobile communication device 102.

The digital authorization certificate storage module 404 stores the digital authorization certificate of the authority 104. The authority transmitter module 406 transmits the data signals and the authorization message to the mobile communication device 102. The authority receiver module 408 receives the information signals and the response signals transmitted by the mobile communication device 102.

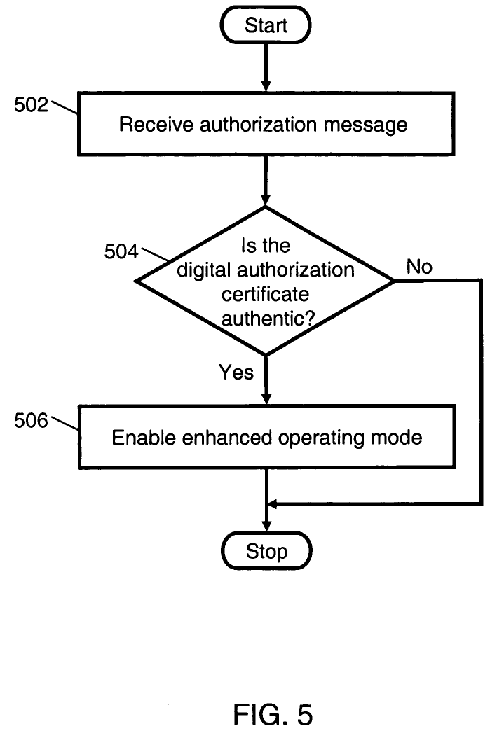

FIG. 5 is a flowchart illustrating a method for enabling the enhanced operating mode of the mobile communication device 102, in accordance with an embodiment of the present invention. At step 502, the authorization message is received from the authority 104. At step 504, the authorization message is checked for the authenticity of the authority 104. If the digital authorization certificate is authentic, the enhanced operating mode of the mobile communication device 102 is enabled at step 506, in accordance with the instructions in the authorization message.

Various embodiments of the present invention as described above have the advantage that the enhanced operating mode allows communication between the mobile communication device and the authority over large distances by increasing the transmission range of the mobile communication device. A direct communication between the mobile communication device and the authority can also be established in the absence of a transceiver tower of a mobile network. Further, the authority can communicate with the mobile communication device, even when the mobile communication device is running low on power. This is achieved by using the reserve power and/or disabling a receiver of the mobile communication device. Additionally, the method can be used to determine the location of the user in an emergency, even if he/she is unable to provide his location information. This enables the effective execution of quick and low-cost rescue operations.

It will be appreciated the mobile communication device and the computer program product described herein may be comprised of one or more conventional processors and unique stored program instructions that control the one or more processors to implement, in conjunction with certain non-processor circuits, some, most, or all of the functions of the mobile communication device and computer program product described herein. The non-processor circuits may include, but are not limited to, a radio receiver, a radio transmitter, signal drivers, clock circuits, power source circuits, and user input devices. As such, these functions may be interpreted as steps of a method to perform the enablement of the enhanced operating mode of the mobile communication device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for enabling an enhanced operating mode of a mobile communication device, the method comprising:
receiving an authorization message from an authority;
authenticating the authorization message; and
enabling the enhanced operating mode of the mobile communication device in response to authenticating the authorization message.

2. A method for enabling an enhanced operating mode of a mobile communication device as defined in claim 1, wherein the enhanced operating mode comprises adjusting at least one transmit parameter of the mobile communication device.

3. A method for enabling an enhanced operating mode of a mobile communication device as defined in claim 2, wherein adjusting at least one transmit parameter comprises increasing a transmit power to an enhanced level.

4. A method for enabling an enhanced operating mode of a mobile communication device as defined in claim 2, wherein adjusting at least one transmit parameter comprises adjusting a transmit timing sequence of the mobile communication device.

5. A method for enabling an enhanced operating mode of a mobile communication device as defined in claim 2, wherein adjusting at least one transmit parameter comprises transmitting a response signal on receiving a request signal from the authority.

6. A method for enabling an enhanced operating mode of a mobile communication device as defined in claim 2, wherein adjusting at least one transmit parameter comprises periodically transmitting an information signal.

7. A method for enabling an enhanced operating mode of a mobile communication device as defined in claim 2, wherein adjusting at least one transmit parameter comprises transmitting location information of the mobile communication device.

8. A method for enabling an enhanced operating mode of a mobile communication device as defined in claim 2, wherein adjusting at least one transmit parameter comprises enabling a direct communication mode between the mobile communication device and the authority.

9. A method for enabling an enhanced operating mode of a mobile communication device as defined in claim 2, wherein the enhanced operating mode further comprises enabling a power-saving mode of the mobile communication device.

10. A method for enabling an enhanced operating mode of a mobile communication device as defined in claim 9, wherein the power-saving mode of the mobile communication device comprises disabling a receiving mode of the mobile communication device.

11. A method for enabling an enhanced operating mode of a mobile communication device as defined in claim 1, wherein the enhanced operating mode comprises indicating to a user of the mobile communication device that the authorization message has been received.

12. A method for enabling an enhanced operating mode of a mobile communication device as defined in claim 1, wherein the enhanced operating mode comprises establishing a communication link with the authority.

13. A method for enabling an enhanced operating mode of a mobile communication device as defined in claim 12, wherein the enhanced operating mode comprises indicating to a user of the mobile communication device that the link has been established with the authority.

14. A method for enabling an enhanced operating mode of a mobile communication device as defined in claim 1, wherein receiving the authorization message from the authority comprises receiving a digital authorization certificate.

15. A method for enabling an enhanced operating mode of a mobile communication device as defined in claim 1, wherein the method further comprises identifying a location of the mobile communication device.

16. A method for enabling an enhanced operating mode of a mobile communication device as defined in claim 15, wherein identifying the location of the mobile communication device comprises processing an information signal transmitted by the mobile communication device to identify location of the mobile communication device.

17. A method for enabling an enhanced operating mode of a mobile communication device as defined in claim 15, wherein identifying the location of the mobile communication device comprises using a triangulation technique.

18. A mobile communication device having an enhanced operating mode, comprising:
means for receiving an authorization message, the authorization message being received from an authority;
means for authenticating the authorization message; and
means for providing the enhanced operating mode of the mobile communication device.

19. A mobile communication device as defined in claim 18, wherein the means for authenticating the authorization message comprises a means for authenticating a digital authorization certificate received in the authorization message.

20. A mobile communication device as defined in claim 18, wherein the means for providing the enhanced operating mode comprises a means for varying the transmit power.
